(19) United States
(12) Patent Application Publication
(10) Pub. No.: US 2018/0194936 A1
(43) Pub. Date: Jul. 12, 2018

(54) Method for Preparing a Simultaneous Interpenetrating Network Comprising Epoxy and Vinyl Polymers for Epoxy Thermosets with Extended Outdoor Ultraviolet Weatherability

(71) Applicant: Christopher Robert Fenoli, Flint, TX (US)

(72) Inventor: Christopher Robert Fenoli, Flint, TX (US)

(21) Appl. No.: 15/837,895

(22) Filed: Dec. 11, 2017

Related U.S. Application Data
(60) Provisional application No. 62/444,881, filed on Jan. 11, 2017.

(51) Int. Cl. C08L 63/04

(52) U.S. Cl. CPC C08L 63/04; C08L 2201/08; C08L 2205/04

(57) ABSTRACT

A method for preparing a simultaneous interpenetrating network (SIN) comprising epoxy and vinyl polymers for epoxy thermosets with extended outdoor ultraviolet weatherability produces a durable hybrid network incorporating epoxy resins and vinyl esters. A quantity of epoxy resin is homogenously mixed with the quantity of vinyl ester to form a precured mixture. The precured mixture is cured into an interpenetrating network that is stronger than curing the substances separately. The cured interpenetrating network is a durable coating material that is resistant to damage from environmental exposure, such as ultraviolet light, and resistant to changes in color over time in extended outdoor exposure.

The current application claims a priority to the U.S. Provisional Patent application Ser. No. 62/444,881 filed on Jan. 11, 2017.

### FIELD OF THE INVENTION

The present invention relates generally to material coating methods. More specifically, the present invention is a method for preparing a simultaneous interpenetrating polymer network having an epoxy network intertwined with a vinyl ester network.

### BACKGROUND OF THE INVENTION

The present invention differs from previous interpenetrating polymer networks (IPNs) in the implementation of a single cure by an amine curing agent to form an intertwined Simultaneous Polymer Network (SPN). Traditionally, dual cure mechanisms have been commonly implemented to cure the epoxy or acrylate, where a thermal or radical cure is implemented. The present invention involves the formation of simultaneous interpenetrating networks, where two distinct monomers are combined and cured simultaneously at room temperature by an amine curing agent through a nucleophilic attack. The present invention is directed to create modified epoxy-polyamine/vinyl ester-polyamine thermoset coatings for improved outdoor ultraviolet (UV) weatherability. Epoxy coatings possess many advantageous properties as a direct to metal (DTM) coating for steel. Epoxy coatings have excellent chemical resistance, salt fog resistance, abrasion resistance, and exhibit easy application properties, especially for high coating thickness applications. However, the resistance of epoxy thermosets to UV light in outdoor applications is very poor. The outdoor UV weatherability of an epoxy film depends upon the epoxy resin, the amine curing agent, and addition of various additives to increase the UV resistance of these coatings to UV light. Still, the best modified bisphenol epoxies and cycloaliphatic epoxy resins still suffer from poor UV stability. Even when combining these resin systems with cycloaliphatic amines or modified polyamides, the overall gloss retention, color retention, and yellowing over extended UV weatherability testing is poor. In recent years, the UV properties have been improved by the implementation of various UV absorbers, antioxidants, and silanes. Unfortunately, the chemical structure inherent in all epoxy linkages suffer from a lack of UV stability. A structural basis for the susceptibility to photodegradation in epoxy coatings, when using an amine curing agent, has been well studied. In the case of vinyl esters, these systems have been shown to have superior outdoor UV weatherability.

In summary, the addition of (meth)acrylates, i.e. vinyl esters, to an epoxy system via an Aza-Michael reaction has led to interpenetrating polymer networks (IPNs) with 65%+ gloss retention and color difference (ΔE) between pre-cured IPNs and cured IPNs of less than 1 after 1000 hours of UV accelerated weatherability testing.

### BRIEF DESCRIPTION OF THE DRAWINGS

FIG. 1 is a flow diagram for the general steps of the present invention.

FIG. 2 is an ingredient list for the quantity of epoxy resin.

FIG. 3 is an ingredient list for the quantity of vinyl ester.

FIG. 4 is an ingredient list for an embodiment for the quantity of amine curing agent.

FIG. 5 is an ingredient list for an alternate embodiment for the quantity of amine curing agent.

FIG. 6 is an ingredient list for another alternate embodiment for the quantity of amine curing agent.

FIG. 7 is an ingredient list for the precured mixture.

### DETAIL DESCRIPTIONS OF THE INVENTION

All illustrations of the drawings are for the purpose of describing selected versions of the present invention and are not intended to limit the scope of the present invention.

The present invention is a method for preparing a simultaneous interpenetrating network comprising epoxy and vinyl polymers for epoxy thermosets with extended outdoor ultraviolet (UV) weatherability. The present invention produces a coating material with modified matrices comprising of simultaneous polymer networks (SPNs) to improve UV weatherability. The coating material will therefore last longer and remain untarnished from environmental exposure.

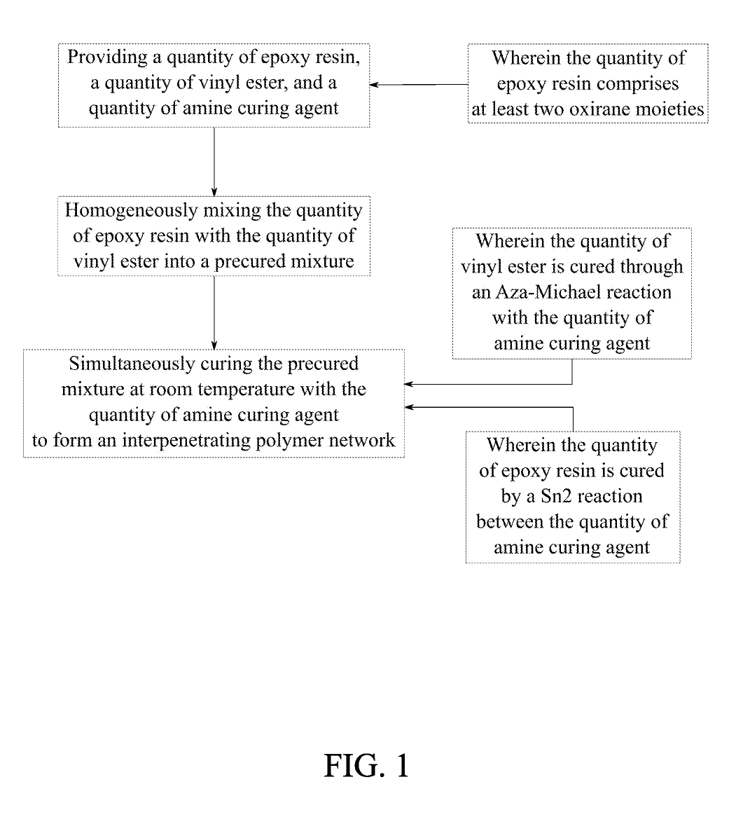

In order to execute the method disclosed by the present invention, a quantity of epoxy resin, a quantity of vinyl ester and a quantity of amine curing agent is needed, as detailed in FIG. 1. The quantity of epoxy resin and the quantity of vinyl ester react simultaneously with the quantity of amine curing agent to form an interpenetrating polymer network (IPN). The quantity of epoxy resin comprises at least two ethylene oxide moieties. The quantity of epoxy resin is homogenously mixed with the quantity of vinyl ester into a precured mixture. The precured mixture is then simultaneously cured at room temperature with the quantity of amine curing agent to form the IPN. The quantity of epoxy resin is cured by a Sₙ2 reaction between the quantity of amine curing agent and the at least two ethylene oxide moieties. The quantity of vinyl ester is cured through an Aza-Michael reaction with the quantity of amine curing agent. As the quantity of epoxy resin and the quantity of vinyl ester cure they impart advantageous physical and chemical properties to the IPN, such as durability to environmental exposure and resistance to discoloration. The IPN is therefore a hybrid of epoxy-polyamine networks and vinyl ester polyamine networks improving environmental and discoloration resistance over each of the original networks.

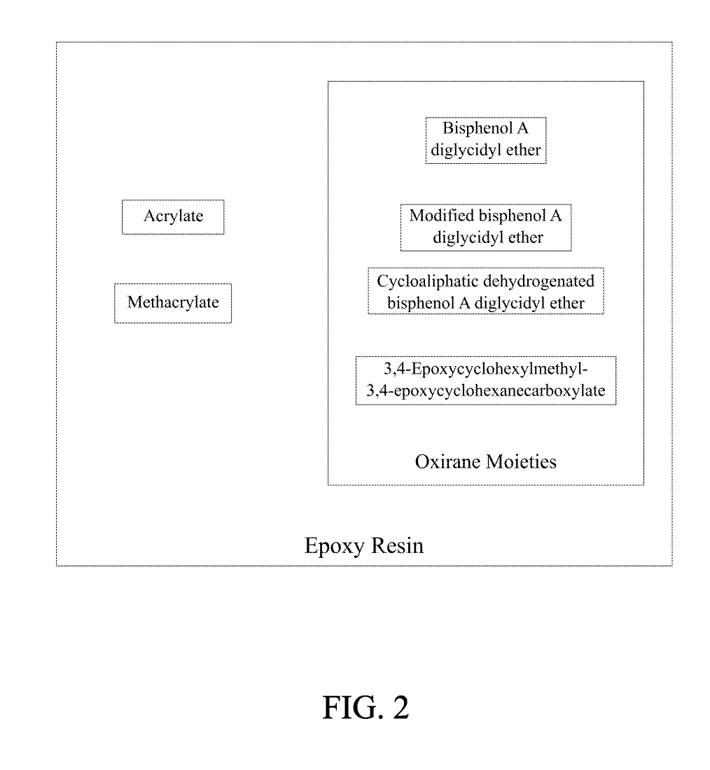

In accordance to FIG. 2, the at least two ethylene oxide moieties are selected from a group consisting of bisphenol A diglycidyl ether, a modified Bisphenol A diglycidyl ether, cycloaliphatic dehydrogenated bisphenol A diglycidyl ether, 3,4-epoxycyclohexylmethyl-3,4-epoxycyclohexanecarboxylate, or a combination thereof.

These compounds have been selected due to the ability to polymerize when in contact with the quantity of amine curing agent. The quantity of epoxy resin is preferred to be approximately 70% of the precured mixture by molar mass in order to provide a sufficient base and desired consistency for the IPN.

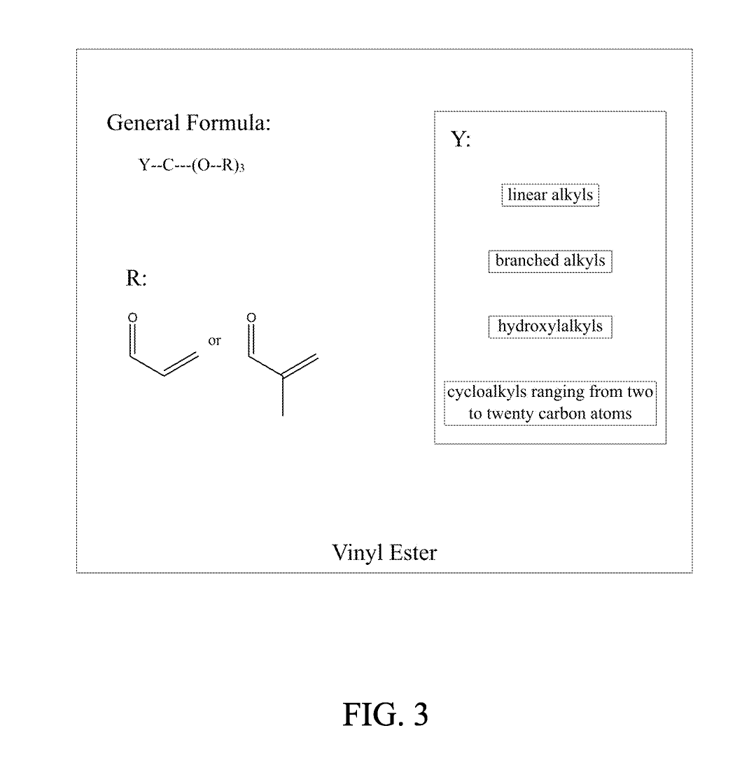

The vinyl ester comprises the general formula: Y—C—(O—R)₃, wherein each R is either an acrylate or methacrylate and Y is selected from a group consisting of linear alkyls, branched alkyls, hydroxylalkyls, or cycloalkyls ranging from two to twenty carbon atoms, as shown in FIG. 3. These compounds are selected due to the ability for the compounds to thermoset into the IPN. The quantity of vinyl ester is between 1% and 30% of the precured mixture by molar mass

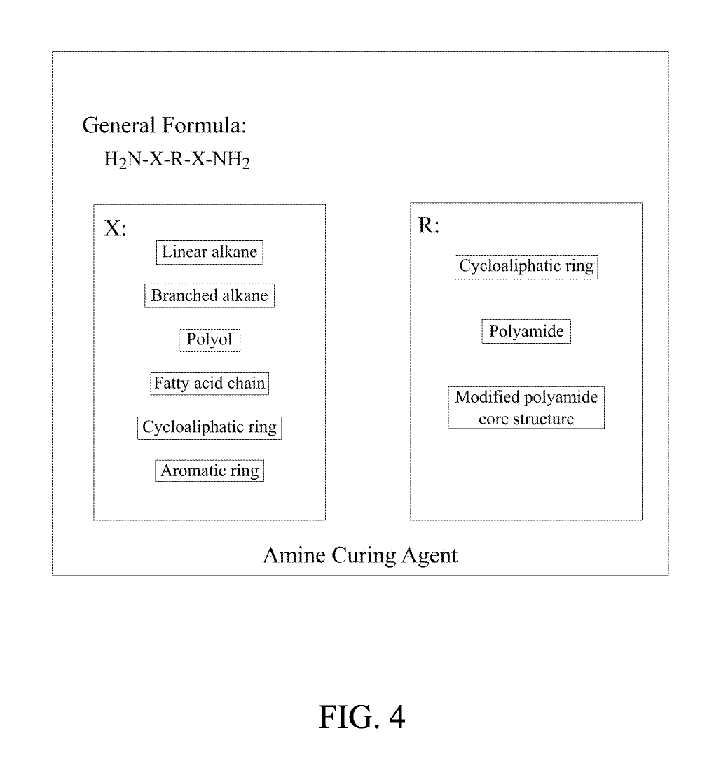

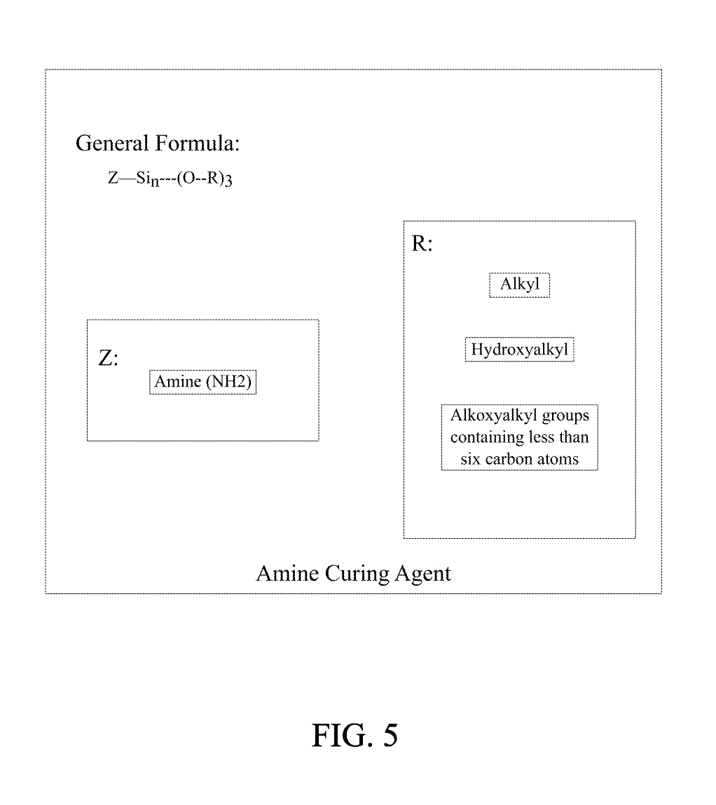

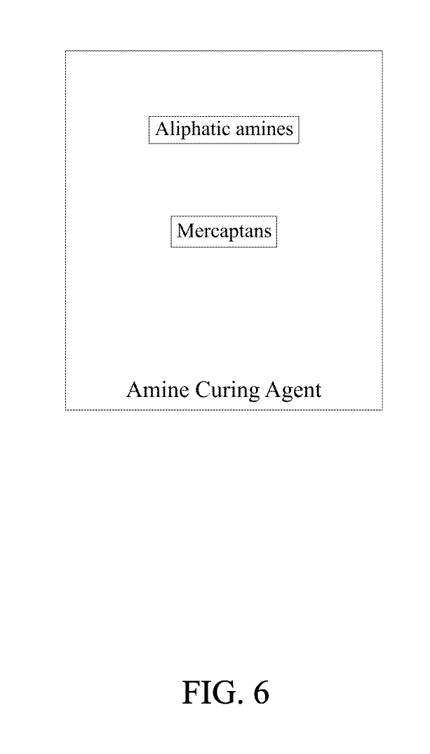

In accordance to the preferred embodiment of the present invention, the quantity of amine curing agent comprises the general formula: H2N—X—R—X—NH2, wherein X is a linear alkane, branched alkane, polyol, fatty acid chain, cycloaliphatic ring, aromatic ring, or any combination thereof, and wherein R is a cycloaliphatic ring, polyamide, or modified polyamide core structure, as detailed in FIG. 4. In some alternate embodiments of the present invention, the quantity of amine curing agent comprises the general formula Z—Siₙ—(O—R)₃, wherein Z is an amine (NH₂) that is attached to the Si by a linear or branched alkyl group or aryl group and wherein R is independently selected from the group consisting of alkyl, hydroxyalkyl, and alkoxyalkyl groups containing less than six carbon atoms, as shown in FIG. 5. For some other alternate embodiments of the present invention, the quantity of amine curing agent is selected from a group consisting of aliphatic amines, mercaptans, and combinations thereof, in accordance to FIG. 6. Each embodiment for the quantity of amine curing agent is chosen depending on the desired application for the IPN. The molar ratio of the quantity of amine curing agent to the quantity of epoxy resin is between 0.6 and 1.2, such that the quantity of amine curing agent is sufficient to react with the quantity of epoxy resin and the quantity of vinyl ester without being in a sufficient excess. The molar mass of the quantity of amine curing agent is chosen to the quantity of epoxy resin to maximize the desired properties of the IPN.

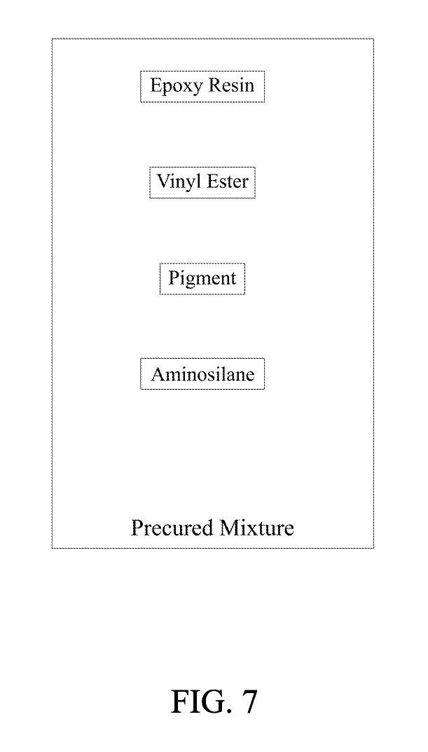

In some embodiments to provide an aesthetic appeal to a surface the IPN is applied to, the present invention comprises a quantity of pigment, as shown in FIG. 7. The quantity of pigment imparts color to the present invention. The quantity of pigment is heterogeneously mixed into the precured mixture. The quantity of pigment is between 1% and 25% of the precured mixture by volume in order to have the color of the pigment accentuate the IPN.

In implementation of the present invention, the precured mixture is applied to a desired surface. The precured mixture is coated onto the desired surface to a thickness between 4 and 25 mils to coat and protect the desired surface. The precured mixture is cured to form an IPN layer on the desired surface. The IPN can be applied to new construction, blasted steel, and over inorganic primers, including those containing anti-corrosion pigments, such as metallic zinc.

To generate an IPN in accordance to the present invention, the cure rates for the quantity of epoxy resin and the quantity of vinyl ester must be relatively balanced to achieve a thermoset with good overall percent conversion and a high gloss finish. If the cure rates are too disproportionate to each other, the overall physical and chemical properties of the IPN will be affected negatively. Since the Aza-Michael addition is a kinetically faster reaction with respect to the Sₙ2 reaction, considerations must be taken to guarantee complete reaction of the epoxy network forming an overall coating with high conversion, high gloss, and no defects, such as an inhibitor to reduce the reaction rate of the Aza-Michael addition. The inhibitor includes, but is not limited to, toluene, xylene, or a similar hydrocarbon that has low polarity or is nonpolar that is suitable for limiting the reaction rate of the Aza-Michael addition.

In some embodiments of the present invention, a quantity of aminosilane is used to covalently bond to the quantity of epoxy resin and to the quantity of vinyl ester, imparting additional UV weatherability to the IPN, as detailed in FIG. 7. The quantity of aminosilane is homogenously mixed into the precured mixture. The quantity of aminosilane is approximately 1 to 10% by weight of the precured mixture. As the quantity of aminosilane is dispersed throughout the precured mixture, the quantity of aminosilane improves the UV weatherability properties of the IPN when cured.

The embodiments of the present invention will be further examined and explained in the following examples:

### Example 1

The quantity of epoxy resin is a mixture of 285 grams (g) of bisphenol A diglycidyl ether based epoxy resin, 32 g of bisphenol A diglycidyl ether and epichlorohydrin epoxy resin, and 44 g of trimethylolpropane triacrylate with 2.5 percent by weight (wt %) carbon black as the quantity of pigment. The quantity of vinyl ester is a solution 24 percent by volume (vol %) aliphatic solvent and 6 vol % dibasic ester with 4 vol % of xylene inhibitor. The quantity of amine curing agent is made by mixing 164 g cycloaliphatic amine and 18 g of aminoethylaminopropyltrimethoxysilane. A xylene inhibitor is mixed into the quantity of epoxy resin at a quantity of approximately 5.5 vol % of the xylene inhibitor and quantity of epoxy resin mixture. The quantity of epoxy resin and quantity of amine curing agent are mixed into a precursor mixture. The precursor mixture is then cured using the quantity of amine curing mixture to generate the IPN. The IPN is sprayed onto a desired surface and allowed to cure under ambient conditions to form a coating with a thickness between 6 and 18 mils. The final coating displays extended UV weatherability over current exterior direct-to-metal (DTM) epoxy coatings.

### Example 2

The quantity of epoxy resin is a mixture consisting of 285 g of bisphenol A diglycidyl ether based epoxy resin, 32 g of bisphenol A diglycidyl ether and epichlorohydrin epoxy resin, and 9 g of trimethylolpropane triacrylate, and 12 g of ainoethylaminopropyltrimethoxysilane. The small amount of aminosilane forms a prepolymer with the quantity of epoxy. The quantity of amine curing agent is a mixture of 164 g of cycloaliphatic amine, 6 g of aminoethylaminopropyltrimethoxysilane, and 35 g of trimethylolpropane triacrylate. The trimethylolpropane triacrylate is allowed to react with the quantity of aminosilane prior to the quantity of epoxy resin being mixed with the quantity of vinyl ester. A solution of 5.5 vol % xylene is prepared with the quantity of epoxy resin. The quantity of vinyl ester is a solution of 4 vol % xylene inhibitor, 24 vol % aliphatic solvent, and 6 vol % of dibasic ester. The solution of xylene and the quantity of epoxy resin is mixed with the quantity of vinyl ester to form a precured mixture. The precured mixture is then cured into the IPN using the quantity of amine curing agent. The IPN is sprayed onto the desired surface and allowed to cure under ambient conditions to form a coating having a thickness of 4-25 mils.

### Example 3

The quantity of epoxy resin is a mixture of 145 g of bisphenol A diglycidyl ether based epoxy resin, 125 g of bisphenol A diglycidyl ether and epichlorohydrin epoxy resin, and 44 g of trimethylolpropane triacrylate. The quantity of amine curing agent is a mixture of 178 g cycloaliphatic amine and 18 g aminoethylaminopropyltrimethoxysilane. The quantity of epoxy resin is mixed with the xylene inhibitor to form a 10% xylene epoxy solution. The quantity of vinyl ester is a solution that is approximately 3 vol % of xylene inhibitors, 20 vol % of aliphatic solvent, and 5.5% dibasic ester. The xylene epoxy solution and the quantity of vinyl are mixed to generate the precured mixture. The precured mixture is cured through use of the quantity of amine curing agent to form the IPN. The IPN is sprayed onto the desired surface and allowed to cure under ambient conditions to form a coating having a thickness of 4-25 mils.

### Example 4

The quantity of epoxy resin is a mixture of 145 g of bisphenol A diglycidyl ether based epoxy resin, 125 g of bisphenol A diglycidyl ether and epichlorohydrin epoxy resin, and 9 g of trimethylolpropane triacrylate, and 12 g of aminoethylaminopropyltrimethoxysilane. The quantity of amine curing agent is a mixture of 178 g cycloaliphatic amine, 6 g of aminoethylaminopropyltrimethoxysilane, and 35 g of trimethylolpropane triacrylate. The quantity of aminosilane forms a prepolymer with the quantity of epoxy resin. A prepolymer and xylene solution is made from the prepolymer and a quantity of xylene inhibitor, wherein the quantity of xylene inhibitor is approximately 10 vol % of the prepolymer and xylene solution. The quantity of vinyl ester is a solution of 3 vol % xylene, 20 vol % of aliphatic solvent, and 5 vol % of dibasic ester. The prepolymer and xylene solution is mixed with the quantity of vinyl ester into a precured mixture. The precured mixture is then cured into the IPN using the quantity of amine curing agent. The IPN is sprayed onto the desired surface and allowed to cure under ambient conditions to form a coating having a thickness of 4-25 mils.

### Example 5

The quantity of epoxy resin is a mixture of 185 g of bisphenol A diglycidyl ether based epoxy resin, 100 g of bisphenol A diglycidyl ether and epichlorohydrin epoxy resin, and 44 g of trimethylolpropane triacrylate. An epoxy xylene solution is made from the quantity of epoxy resin and a quantity of xylene inhibitor, wherein the quantity of xylene inhibitor is approximately 10 vol % of the epoxy xylene solution. The quantity of vinyl ester is a solution that is 3 vol % of xylene inhibitors, 20 vol % aliphatic solvent, and 5.5% of dibasic ester. The quantity of amine curing agents is a mixture of 178 g cycloaliphatic amine and 18 g of Aminoethylaminopropyltrimethoxysilane. The epoxy xylene solution is mixed with the vinyl ester to form the precured mixture. The precured mixture is cured into the IPN with the quantity of amine curing agents. The IPN is sprayed and allowed to cure under ambient conditions to form a coating having a thickness of 4-25 mils.

### Example 6

The quantity of epoxy resin is a mixture of 180 g of bisphenol A diglycidyl ether based epoxy resin, 100 g of Bisphenol A diglycidyl ether and epichlorohydrin epoxy resin, and 9 g of trimethylolpropane triacrylate, and 12 g of Aminoethylaminopropyltrimethoxysilane. The quantity of aminosilane is mixed with the quantity of epoxy resin to form a prepolymer mixer. The quantity of amine curing agent is a mixture of 178 g cycloaliphatic amine, 6 g Aminoethylaminopropyltrimethoxysilane, and 35 g of trimethylolpropane triacrylate. The quantity of prepolymer mixture is mixed into a prepolymer solution with a quantity of xylene inhibitor, wherein the quantity of xylene inhibitor is approximately 10 vol % of the solution. The quantity of vinyl ester is a solution of 3 vol % of xylene, 20 vol % of aliphatic solvent, and 5 vol % of dibasic ester. The prepolymer solution is mixed with the quantity of vinyl ester to form a precured mixture. The precured mixture is then cured into the IPN. The IPN is sprayed onto a desired surface and allowed to cure under ambient conditions to form a coating having a thickness of 4-25 mils.

### Example 7

The quantity of epoxy resin is a mixture of 267 g of bisphenol A diglycidyl ether based epoxy resin, 44 g of trimethylolpropane triacrylate, and 50 g of xylene inhibitor. The quantity of pigment is a mixture of 157 g of titanium dioxide and 25 g of a barytes filler. The quantity of pigment is homogenously mixed with the quantity of epoxy resin. The quantity of amine curing agent is a mixture of 18 g of aminoethylaminopropyltrimethoxysilane, and 158 g of cycloaliphatic amine. The quantity of vinyl ester is a mixture of 5 g of a nonyphenol inhibitior, 105 g of aliphatic solvent, and 25 g of dibasic ester. The quantity of epoxy resin is mixed with the quantity of vinyl ester to form a precured mixture. The precured mixture is then cured into the IPN. The IPN is sprayed onto a desired surface and allowed to cure under ambient conditions to form a coating having a thickness of 4-25 mils.

Although the invention has been explained in relation to its preferred embodiment, it is to be understood that many other possible modifications and variations can be made without departing from the spirit and scope of the invention as hereinafter claimed.

What is claimed is:

1. A method for preparing a simultaneous interpenetrating network comprising epoxy and vinyl polymers for epoxy thermosets with extended outdoor ultraviolet weatherability comprises the steps of:
providing a quantity of epoxy resin, a quantity of vinyl ester, and a quantity of amine curing agent, wherein the quantity of epoxy resin comprises at least two oxirane moieties;
homogeneously mixing the quantity of epoxy resin with the quantity of vinyl ester into a precured mixture;
simultaneously curing the precured mixture at room temperature with the quantity of amine curing agent to form an interpenetrating polymer network, wherein the quantity of epoxy resin is cured by a Sₙ2 reaction between the quantity of amine curing agent and the at least two oxirane moieties and wherein the quantity of vinyl ester is cured through an Aza-Michael reaction with the quantity of amine curing agent;

2. The method for preparing a simultaneous interpenetrating network comprising epoxy and vinyl polymers for epoxy thermosets with extended outdoor ultraviolet weatherability, as claimed in claim 1, wherein the quantity of epoxy resin is selected from a group consisting of an acrylate, methacrylate, or combinations thereof.

3. The method for preparing a simultaneous interpenetrating network comprising epoxy and vinyl polymers for epoxy thermosets with extended outdoor ultraviolet weatherability, as claimed in claim 1, wherein the vinyl ester comprises the general formula: Y—C—(O—R)₃, wherein each R is either an acrylate or methacrylate and Y is selected from a group consisting of linear alkyls, branched alkyls, hydroxylalkyls, or cycloalkyls ranging from two to twenty carbon atoms.

4. The method for preparing a simultaneous interpenetrating network comprising epoxy and vinyl polymers for epoxy thermosets with extended outdoor ultraviolet weatherability, as claimed in claim 1, wherein the quantity of amine curing agent comprises the general formula: H₂N—X—R—X—NH₂, wherein X is a linear alkane, branched alkane, polyol, fatty acid chain, cycloaliphatic ring, aromatic ring, or any combination thereof, and wherein R is a cycloaliphatic ring, polyamide, or modified polyamide core structure.

5. The method for preparing a simultaneous interpenetrating network comprising epoxy and vinyl polymers for epoxy thermosets with extended outdoor ultraviolet weatherability, as claimed in claim 1, wherein the quantity of amine curing agent comprises the general formula Z—Siₙ—(O—R)₃, wherein Z is an amine (NH₂) that is attached to the Si by a linear or branched alkyl group or aryl group and wherein R is independently selected from the group consisting of alkyl, hydroxyalkyl, and alkoxyalkyl groups containing less than six carbon atoms.

6. The method for preparing a simultaneous interpenetrating network comprising epoxy and vinyl polymers for epoxy thermosets with extended outdoor ultraviolet weatherability, as claimed in claim 1, wherein the quantity of amine curing agent is selected from a group consisting of aliphatic amines, mercaptans, and combinations thereof.

7. The method for preparing a simultaneous interpenetrating network comprising epoxy and vinyl polymers for epoxy thermosets with extended outdoor ultraviolet weatherability, as claimed in claim 1, wherein the oxirane moieties is selected from a group consisting of bisphenol A diglycidyl ether, a modified bisphenol A diglycidyl ether, cycloaliphatic dehydrogenated bisphenol A diglycidyl ether, 3,4-epoxycyclohexylmethyl-3,4-epoxycyclohexanecarboxylate, or a combination thereof.

8. The method for preparing a simultaneous interpenetrating network comprising epoxy and vinyl polymers for epoxy thermosets with extended outdoor ultraviolet weatherability, as claimed in claim 1, wherein the quantity of vinyl ester is between 1% and 30% of the precured mixture by molar mass.

9. The method for preparing a simultaneous interpenetrating network comprising epoxy and vinyl polymers for epoxy thermosets with extended outdoor ultraviolet weatherability, as claimed in claim 1, wherein the quantity of epoxy resin is approximately 70% of the precured mixture by molar mass.

10. The method for preparing a simultaneous interpenetrating network comprising epoxy and vinyl polymers for epoxy thermosets with extended outdoor ultraviolet weatherability, as claimed in claim 1, wherein the molar ratio of the quantity of amine curing agent to the quantity of epoxy resin is between 0.6 and 1.2.

11. The method for preparing a simultaneous interpenetrating network comprising epoxy and vinyl polymers for epoxy thermosets with extended outdoor ultraviolet weatherability, as claimed in claim 1, comprises the steps of:
providing a quantity of pigment;
heterogeneously mixing the quantity of pigment into the precured mixture;

12. The method for preparing a simultaneous interpenetrating network comprising epoxy and vinyl polymers for epoxy thermosets with extended outdoor ultraviolet weatherability, as claimed in claim 12, wherein the quantity of pigment is between 1% and 25% of the precured mixture by volume.

13. The method for preparing a simultaneous interpenetrating network comprising epoxy and vinyl polymers for epoxy thermosets with extended outdoor ultraviolet weatherability, as claimed in claim 1, comprises the step of:
applying the precured mixture to a surface;

14. The method for preparing a simultaneous interpenetrating network comprising epoxy and vinyl polymers for epoxy thermosets with extended outdoor ultraviolet weatherability, as claimed in claim 14, wherein the precured mixture is coated onto the surface to a thickness between 4 and 25 mils.

15. The method for preparing a simultaneous interpenetrating network comprising epoxy and vinyl polymers for epoxy thermosets with extended outdoor ultraviolet weatherability, as claimed in claim 1, comprises the steps of:
providing a quantity of aminosilane;
homogenously mixing the quantity of aminosilane into the precured mixture;

16. The method for preparing a simultaneous interpenetrating network comprising epoxy and vinyl polymers for epoxy thermosets with extended outdoor ultraviolet weatherability, as claimed in claim 1, wherein the quantity of aminosilane is approximately 1 to 10% by weight of the precured mixture.
